(19) United States
(12) Patent Application Publication
(10) Pub. No.: US 2025/0246108 A1
(43) Pub. Date: Jul. 31, 2025

(54) DISPLAY METHOD OF ELECTRONIC DEVICE, ELECTRONIC DEVICE, AND APPARATUS

(71) Applicant: Lenovo (Beijing) Limited, Beijing (CN)

(72) Inventors: Yang XU, Beijing (CN); Helai WANG, Beijing (CN)

(21) Appl. No.: 19/030,993

(22) Filed: Jan. 17, 2025

(30) Foreign Application Priority Data
Jan. 31, 2024 (CN) 202410139997.2

(51) Int. Cl. G09G 3/00

(52) U.S. Cl. CPC G09G 3/035; G09G 2340/0464

(57) ABSTRACT

An electronic device includes a first antenna, a second antenna, and a target device. The first antenna is arranged at a first position and is configured as a transmission antenna to radiate a first radio frequency (RF) signal of a target frequency band. The second antenna is arranged at a second position different from the first position and is configured as a receiving antenna to receive a second RF signal of the target frequency band. The target device is arranged at a third position and is configured to generate a third RF signal of the target frequency band. The third RF signal is used to reduce an impact of the first RF signal on the second antenna receiving the second RF signal. The third position is different from the second position and the first position.

### CROSS-REFERENCE TO RELATED APPLICATION

The present disclosure claims priority to Chinese Patent Application No. 202410139997.2, filed on Jan. 31, 2024, the entire content of which is incorporated herein by reference.

### TECHNICAL FIELD

The present disclosure is related to the display technology field and, more particularly, to an electronic device, a display method of the electronic device, and an apparatus.

### BACKGROUND

Display screens with variable sizes have been used in electronic devices. In related art, when a display screen with a variable size is expanded or rolled, the display position of the visual subject in the display screen is fixed on the expanded part of the display screen, which impairs the visual experience by the user.

### SUMMARY

An aspect of the present disclosure provides an electronic device, including a first antenna, a second antenna, and a target device. The first antenna is arranged at a first position and is configured as a transmission antenna to radiate a first radio frequency (RF) signal of a target frequency band. The second antenna is arranged at a second position different from the first position and is configured as a receiving antenna to receive a second RF signal of the target frequency band. The target device is arranged at a third position and is configured to generate a third RF signal of the target frequency band. The third RF signal is used to reduce an impact of the first RF signal on the second antenna receiving the second RF signal. The third position is different from the second position and the first position.

### BRIEF DESCRIPTION OF THE DRAWINGS

FIG. 1 illustrates a schematic flowchart of a display method of an electronic device according to some embodiments of the present disclosure.

FIG. 2 illustrates a schematic diagram showing a startup process of a laptop having a flexible screen according to some embodiments of the present disclosure.

FIG. 3 illustrates a schematic flowchart of a display method of an electronic device according to some embodiments of the present disclosure.

FIG. 4 illustrates a schematic structural diagram of an electronic device according to some embodiments of the present disclosure.

FIG. 5 illustrates a schematic structural diagram of a task processing apparatus according to some embodiments of the present disclosure.

FIG. 6 illustrates a schematic diagram showing hardware of an electronic device according to some embodiments of the present disclosure.

### DETAILED DESCRIPTION OF THE EMBODIMENTS

Embodiments of the present disclosure provide a display method for an electronic device. The method can be executed by a processor of a computer device. The computer device can include devices capable of data processing, such as servers, laptops, tablets, desktop computers, smart TVs, set-top boxes, mobile devices (e.g., mobile phones, portable video players, personal digital assistants, dedicated messaging devices, portable gaming devices), etc. FIG. 1 illustrates a schematic flowchart of a display method of an electronic device according to some embodiments of the present disclosure. The electronic device can include a display screen with a variable size. As shown in FIG. 1, the method includes step S101 to step S103.

At S101, in response to detecting that a first size parameter of the expanded portion of the display screen is updated, the updated first size parameter is obtained.

The electronic device can be any device with a display screen of variable size and is not limited here. For example, the electronic device can include a laptop, a desktop computer, or a smartphone. The display screen with variable size can include a flexible screen, a foldable screen, or a curved screen, which is not limited here. In addition, the first size parameter can be any parameter that represents the size of the expanded portion of the display screen, which is not limited here. For example, the first size parameter can be an expanded length of the expanded portion of the display screen or an expanded area of the expanded portion of the display screen.

In some embodiments, a sensor embedded inside the electronic device can be configured to monitor the change in the first size parameter of the expanded portion of the display screen in real time. When the sensor detects that the first size parameter of the expanded portion of the display screen is updated, the sensor can send the data to the processor or the operating system to obtain the updated first size parameter.

At S102, based on the updated first size parameter, a display position of a target object displayed on the expanded portion of the display screen is updated to obtain the updated display position.

The target object can be a visual subject in the display image, and the display image can be displayed at the expanded portion of the display screen. The visual subject can refer to a most prominent object with a specific shape in the display image, which is a primary factor attracting the attention of a viewer and a core for the image organization. For example, the target object can include an icon (logo, logotype), an object occupying the largest area in the display image, or an object in a special position such as the center, which is not limited here.

In some embodiments, based on the updated first size parameter, the display position of the target object can be updated by using a pre-set layout strategy to obtain the updated display position. Then, the updated display position can be applied to the target object to cause the target object to move to the new coordinate.

In some embodiments, an anchor relationship can first be established between a first target point on the target object and a second target point on the expanded portion of the display screen. After the first size parameter is updated, the display position of the target object can be recalculated based on the updated first size parameter and the anchor relationship to obtain the updated display position.

At S103, based on the updated display position, the target object is displayed.

In some embodiments, after the updated display position of the target object is obtained, the updated display position can be applied to the target object to cause the target object to move to a new coordinate point on the expanded portion of the display screen. For example, when the expanded portion of the display screen becomes larger, the layout adjustment can be performed on the target object to maintain the relative position of the target object unchanged using the updated display position. When the expanded portion of the display screen becomes smaller, the layout adjustment can be performed on the target object to maintain the relative position of the target object unchanged or prevent the target object from being cropped by using the updated display layout to maintain its relative position or avoid being cropped using the updated display position.

In some embodiments, when the display screen is a flexible screen, and the flexible screen expands or contracts, the target object can be displayed on the expanded portion of the flexible screen based on the updated display position.

In some embodiments, when the display screen is a foldable screen, and the foldable screen is folded, the target object can be displayed on one side of the screen. When the foldable screen is unfolded, the target object can be displayed on the expanded foldable screen based on the updated display position.

In embodiments of the present disclosure, in response to detecting that the first size parameter of the expanded portion of the display screen is updated, the updated first size parameter can be obtained. Based on the updated first size parameter, the display position of the target object displayed on the expanded portion of the display screen can be updated to obtain the updated display position. Based on the updated display position, the target object can be displayed. Thus, as the first size parameter of the expanded portion of the display screen changes, the display position of the target object displayed on the expanded portion of the display screen can also be updated accordingly. Then, based on the updated display position, the target object can be displayed. Thus, no matter the degree of expansion of the display screen, users can obtain a relatively consistent and coherent visual and interaction experience, which achieves a good user experience.

In some embodiments, the updated first size parameter can include the updated expanded length of the expanded portion. In step S102, updating the display position of the target object displayed on the expanded portion of the display screen based on the updated first size parameter to obtain the updated display position can include step S111.

At S111, based on a specific distribution ratio and the updated expanded length of the expanded portion, the display position of the target object in the expansion direction of the expanded portion is updated to obtain the updated display position.

In some embodiments, the specific distribution ratio can be the golden ratio. For example, when the updated expanded length of the expanded portion is 20 cm, the updated display position, which is calculated using the golden ratio, can be 12.36 cm. That is, the display position of the target object can be moved to a position 12.36 cm from the lower boundary of the expanded portion. The lower boundary of the expanded portion can correspond to the lower boundary of the display image.

In some embodiments, based on the specific distribution ratio and the updated expanded length of the expanded portion, the display position of the target object in the expansion direction of the expanded portion can be updated, while the display position of the target object in a direction perpendicular to the expansion direction of the expanded portion can remain unchanged, to obtain the updated display position. In some embodiments, a coordinate system can be established in the expanded portion, with the expansion direction of the expanded portion as a Y-axis, the direction perpendicular to the expansion direction of the expanded portion as an X-axis, and the center point of the upper boundary of the expanded portion as the origin. The upper boundary of the expanded portion can correspond to the upper boundary of the display image. For example, when the display position of the target object in the expanded portion is (10, 10), the updated display position can be (10, 13). That is, the X-coordinate value can remain unchanged, and the Y-coordinate value can be updated in real time.

In embodiments of the present disclosure, the display position of the target object in the expansion direction of the expanded portion can be updated based on the specific distribution ratio and the updated expanded length of the expanded portion to obtain the updated display position. Thus, as the expanded length of the expanded portion is updated, the target object can adapt to the updated expanded length of the expanded portion. Then, the target object can be displayed to the user in the most suitable method to effectively improve the user visual experience.

In some embodiments, in step S102, updating the position of the target object displayed on the expanded portion of the display screen based on the updated first size parameter to obtain the updated display position includes step S121 to step S122.

At S121, based on the updated first size parameter, the center position of the expanded portion is determined.

In some embodiments, the center position of the expanded portion can be determined through preset data conversion rules by using the updated first size parameter. In some embodiments, the first size parameter can be the expanded length of the expanded portion. Based on the updated expanded length, the center position of the expanded portion can be calculated through the preset data conversion rules. For example, in the direction of the expanded length, if the expanded length is known to be L, the Y-coordinate of the center position can be obtained by dividing L by 2.

At S122, the display position of the target object is updated to be the center position to obtain the updated display position.

In some embodiments, when the display screen is a flexible screen, and the flexible screen expands or contracts, the target object displayed on the expanded portion of the flexible screen can be in the center position of the expanded portion. That is, the updated display position can be the center position of the expanded portion. For example, the display image can be a peacock background. The target object can be the peacock. As the size of the expanded portion of the flexible screen is updated, the updated display position of the peacock can be always at the center position of the expanded portion. For another example, the display image can be a butterfly-with-open-wings background. The target object can be the butterfly. As the size of the expanded portion of the flexible screen is updated, the updated display position of the butterfly can always be at the center position of the expanded portion. That is, the belly of the butterfly can always be at the center position of the expanded portion.

In embodiments of the present disclosure, the center position of the expanded portion can be determined based on the updated first size parameter. The display position of the target object can be updated to the center position to obtain the updated display position. Thus, the display position of the target object can be updated to be the center position, which is beneficial for the target object to be displayed at the center of the expanded portion. Thus, no matter how the first size parameter of the expanded portion changes, the target object can quickly adapt to the updated first size parameter to provide a consistent and pleasing visual experience for the user.

In some embodiments, in step S111, updating the display position of the target object in the expansion direction of the expanded portion based on the specific distribution ratio and the updated expanded length of the expanded portion to obtain the updated display position can include step S131.

At S131, when the updated expanded length of the expanded portion is less than or equal to a second size parameter, the display position of the target object in the expansion direction of the expanded portion is updated based on the specific distribution ratio and the updated expanded length of the expanded portion to obtain the updated display position.

The second size parameter can be a preset size threshold. In some embodiments, when the updated expanded length of the expanded portion is less than or equal to the preset size threshold (i.e., the second size parameter), the display position of the target object in the expansion direction can be adjusted according to the specific distribution ratio and the current actual expanded length (i.e., the updated expanded length of the expanded portion). For example, the preset size threshold can be the specific ratio of the expanded length when the display screen is fully expanded. The specific ratio can be 60% or 70%, which is not limited here. In some embodiments, when the updated expanded length of the expanded portion is less than or equal to 60% of the expanded length when the expansion portion is fully expanded, the display position of the target object in the expansion direction of the expansion portion can be updated based on the specific distribution ratio and the updated expanded length of the expanded portion to obtain the updated display position.

In embodiments of the present disclosure, when the updated expanded length of the expanded portion is less than or equal to the second size parameter, the display position of the target object in the expansion direction of the expanded portion can be updated based on the specific distribution ratio and the updated expanded length of the expanded portion, to obtain the updated display position. Thus, when the updated expanded length of the expanded portion is less than or equal to the second size parameter, the display position of the target object on the display image can be adjusted flexibly and intelligently to improve the visual experience for the user.

In some embodiments, the method can further include step S141.

At S141, when the updated expanded length of the expanded portion is greater than the second size parameter, the display position of the target object in the expansion direction of the expanded portion is updated based on the specific distribution ratio and the expanded length when the display screen is fully expanded to obtain the updated display position.

In some embodiments, when the updated expanded length of the expanded portion is greater than the preset size threshold (i.e., the second size parameter), the display position of the target object in the expansion direction of the expanded portion can be updated based on the specific distribution ratio and the expanded length when the display screen is fully expanded to obtain the updated display position. In some embodiments, when the updated expanded length of the expanded portion is greater than 60% of the expanded length when the display screen is fully expanded, the display position of the target object in the expansion direction of the display portion can be updated based on the specific distribution ratio and the expanded length when the display screen is fully expanded to obtain the updated display position. If the size length of the expanded portion is always greater than the second size parameter, the display position of the target object on the display screen viewed by the user can be unchanged.

In embodiments of the present disclosure, when the updated size length of the expanded portion is greater than the second size parameter, the display position of the target object in the expansion direction of the expanded portion can be updated based on the specific distribution ratio and the expanded length when the display screen is fully expanded to obtain the updated display position. Thus, when the display screen is sufficiently expanded, the display position of the target object can be automatically adjusted according to the specific distribution ratio and the expanded length when the display screen is fully expanded to improve the visual experience for the user.

In some embodiments, the method further includes step S151 before step S101 of obtaining the updated first size parameter in response to detecting that the first size parameter of the expanded portion of the display screen is updated.

At S151, in response to receiving a telescopic control instruction for the display screen, the display screen is driven to expand or contract and periodically obtain the first size parameter.

The telescopic control instruction can be any instruction used to adjust the expansion degree of the expanded portion of the display screen, which is not limited. For example, the telescopic control instruction can include a power-on instruction, a power-off instruction, a screen telescopic instruction, or a lock-screen instruction.

In some embodiments, the telescopic control instruction can be the power-on instruction. In response to receiving the power-on instruction, the display screen can be driven to expand, and the first size parameter can be periodically obtained.

In some embodiments, the telescopic control instruction can be the power-off instruction. In response to receiving the power-off instruction, the display screen can be driven to contract, and the first size parameter can be periodically obtained.

In some embodiments, the telescopic control instruction can be the lock-screen instruction. In response to receiving the lock-screen instruction, the display screen can be driven to contract, and the first size parameter can be periodically obtained. Driving the display screen to contract and periodically obtaining the first size parameter after receiving the lock-screen instruction can facilitate the display of a target image when the screen is locked, which is more suitable for an application scenario such as an office scenario.

In embodiments of the present disclosure, in response to receiving the telescopic control instruction of the display screen, the display screen can be driven to expand and contract and the first size parameter can be periodically obtained. Thus, the target image can be displayed in real time when the display screen expands and contracts, which can improve the visual experience for the user.

In some embodiments, in step S151, driving the display screen to expand or contract and periodically obtaining the first size parameter in response to receiving the telescopic control instruction of the display screen can include step S161.

At S161, in response to receiving the power-on instruction, the display screen is driven to expand, a basic input/output system (BIOS) controller is powered on, and the first size parameter is periodically obtained.

In some embodiments, the electronic device can also include an embedded controller (EC) and a random access memory (RAM). During implementation, the embedded controller can drive the display screen to expand and power on the BIOS controller in response to receiving the power-on instruction. The embedded controller can periodically obtain the first size parameter and write the first size parameter into the memory.

In step S101, before obtaining the updated first size parameter in response to detecting that the first size parameter of the expanded portion of the display screen is updated, the method can also include steps S171 and S172.

At S171, in response to detecting that the BIOS controller is powered on, the display position of the target object is determined based on the first size parameter that is obtained most recently.

In some embodiments, the embedded controller can drive the BIOS controller to power on in response to receiving the power-on instruction. The BIOS controller can periodically read the first size parameter from memory. After the BIOS controller is powered on, the BIOS controller can determine the display position of the target object based on the first size parameter that is most recently obtained.

At S172, the target object is displayed based on the display position of the target object.

In some embodiments, during the boot process of the electronic device, the target object can be a logo. In some embodiments, the coordinates of the logo of a Boot Graphics Resource Table (BGRT) can be calculated and reported to the operating system boot loader (OS boot loader) to display the logo.

In embodiments of the present disclosure, in response to receiving the power-on instruction, the display screen can be driven to expand, the BIOS controller can be powered on, and the first size parameter can be periodically obtained. In response to detecting that the BIOS controller is powered on, the display position of the target object can be determined based on the first size parameter that is most recently obtained. The target object can be displayed based on the display position of the target object. Since the display position of the target object is determined based on the first size parameter that is most recently obtained after the BIOS controller is powered on, the target object can be displayed in time to improve the visual experience for the user.

In some embodiments, in step S161, in response to receiving the power on instruction, driving the display screen to expand, powering on the BIOS controller, and periodically obtaining the first size parameter can include step S181.

At S181, in response to receiving the power-on instruction, the display screen is driven to expand, the BIOS controller is powered on, and the first size parameter is periodically obtained based on a first time interval.

In some embodiments, in response to receiving the power-on instruction, the display screen can be driven to expand, and the BIOS controller can be powered on. The embedded controller can periodically obtain the first size parameter based on the first time interval and update the memory with the obtained first size parameter.

In Step S101, in response to detecting that the first size parameter of the expanded portion of the display screen is updated, obtaining the updated first size parameter can include step S191.

At S191, in response to detecting that the first size parameter of the expanded portion of the display screen is updated within a second time interval, the updated first size parameter is obtained. The second time interval is greater than or equal to the first time interval.

In some embodiments, after displaying the power-on display object based on the display position, the BIOS controller can periodically obtain the first size parameter from memory based on the second time interval and adjust the display position based on the periodically obtained first size parameter.

In some embodiments, in response to receiving the power-on instruction, the embedded controller can drive the display screen to expand and power on the BIOS controller. The embedded controller can periodically obtain the first size parameter based on the first time interval and update the obtained first size parameter in the memory. The BIOS controller can initialize the display screen, and read and parse the target object. After parsing the target object, the BIOS controller can obtain the first size parameter stored in memory. Then, the BIOS controller can calculate the display position of the target object and display the target object. Subsequently, an event of the BIOS controller having a period of the second time interval can be registered. In response to detecting that the first size parameter of the expanded portion of the display screen is updated within the second time interval, the updated first size parameter can be obtained, and the display position of the target object can be updated.

In some embodiments, the second time interval can be equal to the first time interval. Thus, the frequency of the embedded controller obtaining the first size parameter can be synchronized with the frequency of the BIOS controller obtaining the updated first size parameter. Therefore, the real-time display quality of the target object can be improved.

In some embodiments, in response to receiving the power-on instruction, the display screen can be driven to expand, the BIOS can be powered on, and the first size parameter can be periodically obtained based on the first time interval. In response to detecting that the first size parameter of the expanded portion of the display screen is updated within the second time interval, the updated first size parameter can be obtained. Then, when the electronic device is powered on, the target object can be quickly displayed, and the target object can be subsequently displayed and updated high-efficiently. Thus, the human-machine interactive visual experience can be improved during the power-on process.

In embodiments of the present disclosure, the application of the display method of the electronic device in the actual scenario can be described. For example, the description can be made by taking the Logo display scenario during the power-on process of the electronic device having the flexible screen.

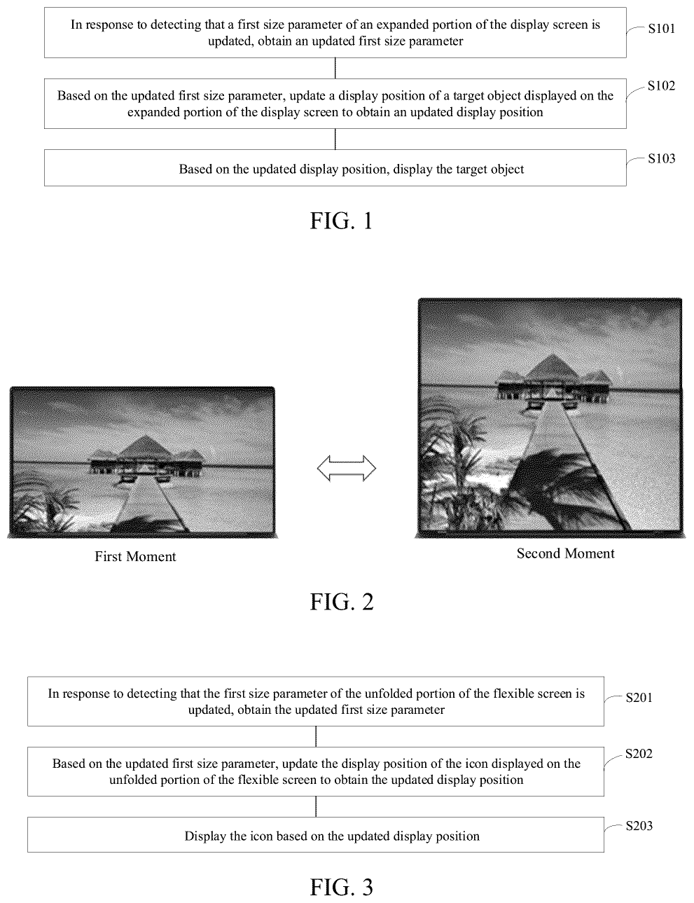

Currently, flexible screens are gradually applied in electronic devices. In related technologies, during the power-on process of an electronic device, the flexible screen can continuously expand, and the power-on logo can rise continuously as the flexible screen expands. The display position of the power-on logo on the expanded portion of the flexible screen can remain fixed and unchanged, and the center of the Logo may be no longer at the golden ratio point in the expansion direction of the expanded portion of the flexible screen, which brings poor visual experience for the user. For example, FIG. 2 illustrates the power-on process of the laptop having the flexible screen. At the first moment during the power-on process, the display position of the power-on logo (visual subject in the scene i.e., the house in the scene) on the expanded portion of the expanded portion. The user has good visual experience. As the flexible screen continues to expand, at the second moment during the power-on process, the display position of the power-on logo on the expanded portion of the flexible screen may no longer be at the golden ratio point in the expansion direction of the expanded portion. Thus, the visual experience of the user can be reduced.

Based on this, embodiments of the present disclosure can provide a display method for an electronic device. The electronic device can include the flexible screen. As shown in FIG. 3, the method includes steps S201 to S203.

At S201, in response to detecting that the first size parameter of the unfolded portion of the flexible screen is updated, the updated first size parameter is obtained.

At S202, based on the updated first size parameter, the display position of the icon displayed on the unfolded portion of the flexible screen is updated to obtain the updated display position.

At S203, the icon is displayed based on the updated display position.

In embodiments of the present disclosure, in response to detecting that the first size parameter of the expanded portion of the flexible screen is updated, the updated first size parameter can be obtained. Based on the updated first size parameter, the display position of the icon on the expanded portion of the flexible screen can be updated to obtain the updated display position. Based on the updated display position, the icon can be displayed. Thus, as the first size parameter of the expanded portion of the flexible screen changes, the display position of the icon on the expanded portion of the flexible screen can be updated accordingly. The icon can be then displayed based on the updated display position. Thus, no matter how the expansion degree of the flexible screen is, the user can obtain a relatively consistent and continuous visual and interactive experience to realize a good user experience.

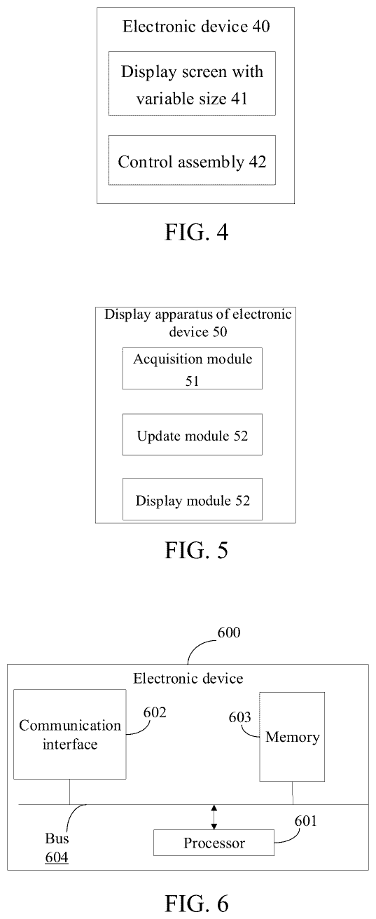

Embodiments of the present disclosure provide an electronic device. As shown in FIG. 4, the electronic device 40 includes a display screen 41 with a variable size and a control assembly 42.

The control assembly 42 can be configured to, in response to detecting that the first size parameter of the expanded portion of the display screen 41 is updated, obtain the updated first size parameter, based on the updated first size parameter, update the display position of the target object displayed on the expanded portion of the display screen 41 to obtain the updated display position, and display the target object based on the updated display position.

Embodiments of the present disclosure provide a display apparatus of an electronic device. The electronic device can include a display screen with a variable size. As shown in FIG. 5, the display apparatus 50 of the electronic device includes an acquisition module 51, an updating module 52, and a display module 53.

The acquisition module 51 can be configured to, in response to detecting that the first size parameter of the expanded portion of the display screen is updated, obtain the updated first size parameter.

The update module 52 can be configured to update the display position of the target object displayed on the expanded portion of the display screen based on the updated first size parameter to obtain the updated display position.

The display module 53 can be configured to display the target object based on the updated display position.

In some embodiments, the updated first size parameter can include the updated expanded length of the expanded portion. The update module 52 can be further configured to update the display position of the target object in the expansion direction of the expanded portion based on the specific distribution ratio and the updated expanded length of the expanded portion to obtain the updated display position.

In some embodiments, the update module 52 can be further configured to determine the center position of the expanded portion based on the updated first size parameter and update the display position of the target object as the center position to obtain the updated display position.

In some embodiments, the update module 52 can be further configured to, when the updated expanded length of the expanded portion is less than or equal to the second size parameter, update the display position of the target object in the expansion direction of the expanded portion based on the specific distribution ratio and the updated expanded length of the expanded portion to obtain the updated display position.

In some embodiments, the display apparatus 50 of the electronic device can further include a first update module 53. The first update module 53 can be configured to, when the updated expanded length of the expanded portion is greater than the second size parameter, update the display position of the target object in the expansion direction of the expanded portion based on the specific distribution ratio and the expanded length when the display screen is fully expanded to obtain the updated display position.

In some embodiments, the display apparatus 50 of the electronic device can further include a drive module 54. The drive module 54 can be configured to, in response to receiving a telescopic control instruction of the display screen, drive the display screen to expand or contract, and periodically obtain the first size parameter.

In some embodiments, the drive module 54 can be further configured to, in response to receiving a power-on instruction, drive the display screen to expand, power up the BIOS controller, and periodically obtain the first size parameter. The display apparatus 50 of the electronic device can further include a determination module 55. The determination module 55 can be configured to, in response to detecting that the BIOS controller is powered on, determine the display position of the target object based on the first size parameter that is most recently obtained, and display the target object based on the display position of the target object.

In some embodiments, the drive module 54 can be further configured to, in response to receiving the power-on instruction, drive the display screen to expand, power up the BIOS controller, and periodically obtain the first size parameter based on a first time interval. The acquisition module 51 can be further configured to, in response to detecting that the first size parameter of the expanded portion of the display screen within the second time interval is updated, obtain the updated first size parameter. The second time interval can be greater or equal to the first time interval.

The description of apparatus embodiments above is similar to the description of method embodiments and has similar beneficial effects. In some embodiments, the functions of or the modules included in the apparatus of embodiments of the present disclosure can be used to perform the method of embodiments of the present disclosure. For technical details not disclosed in the apparatus embodiments of the present disclosure, reference can be made to the description of the method embodiments.

In embodiments of the present disclosure, if the display method of the electronic device described is implemented in the form of software functional modules and sold or used as an independent product, the display method can also be stored in a computer-readable storage medium. Based on this understanding, the essence or the part contributing to the related technology of the technical solution of the present disclosure can be embedded in the form of a software product. The software product can be stored in a storage medium and include several instructions to cause a computer device (e.g., a personal computer, server, or network device) to execute all or a part of the method of embodiments of the present disclosure. The storage medium above can include various media capable of storing program codes, such as a USB drive, a portable hard drive, read-only memory (ROM), magnetic disks, or optical disks. Thus, the present disclosure is not limited to any specific hardware, software, firmware, or any combination thereof.

Embodiments of the present disclosure provide an electronic device, including a memory and a processor. The memory can store a computer program that, when executed by the processor, causes the processor to implement some or all steps of the method described above.

Embodiments of the present disclosure provide a computer-readable storage medium storing a computer program that, when executed by the processor. The computer-readable storage medium can be transient or non-transient.

Embodiments of the present disclosure provide a computer program including computer-readable codes that, when executed by the computer device, cause the processor of the computer device to implement some or all steps of the method described above. The processor can be the processor of embodiments of the present disclosure.

Embodiments of the present disclosure provide a computer program product, including a non-transitory computer-readable storage medium storing the computer program. When the computer program is executed by the computer, some or all steps of the above method can be implemented. The computer program product can be implemented by hardware, software, or a combination thereof. In some embodiments, the computer program product can be a computer-readable storage medium. In some other embodiments, the computer program product can be a software product, e.g., a software development kit (SDK).

The descriptions of various embodiments of the present disclosure above tend to emphasize the differences therebetween, while similarities or identical aspects of embodiments of the present disclosure can be referred to each other. The descriptions of the above device, storage medium, computer program, and computer program product embodiments are similar to the description of the method embodiments above and have similar beneficial effects. For technical details not disclosed in the device, storage media, computer program, or computer program product embodiments of the present disclosure, reference can be made to the description of the method embodiments of the present disclosure.

FIG. 6 illustrates a schematic diagram showing a hardware entity of an electronic device according to some embodiments of the present disclosure. As shown in FIG. 6, the hardware entity of the electronic device 600 includes a processor 601, a communication interface 602, and a memory 603. The processor 601 can be typically configured to control the overall operations of the electronic device 600. The communication interface 602 can be configured to allow the electronic device to communicate with other terminals or servers via a network. The memory 603 can be configured to store instructions and applications executable by the processor 601 and cache data to be processed or already processed by the processor 601 and other modules of the electronic device 600 (e.g., image data, audio data, voice communication data, and video communication data), which can be implemented using flash memory (FLASH) or random access memory (RAM). The data transmission can be performed among the processor 601, communication interface 602, and memory 603 via a bus 604. The processor 601 can be configured to execute the program to implement some or all steps of the method described above or can be the processor of the above embodiments of the present disclosure. The memory 603 can include a cache module provided above.

“An embodiment” or “one embodiment” throughout the specification means that a specific feature, structure, or characteristic related to embodiments of the present disclosure can be included in at least one embodiment of the present disclosure. Thus, “in one embodiment” or “in an embodiment” in the specification does not necessarily refer to the same embodiment. In addition, the specific features, structures, or characteristics can be combined in one or more embodiments in any suitable method. In various embodiments of the present disclosure, the sizes of the numbering of the steps/processes described above do not imply an execution order. The execution sequence should be determined based on the functionality and inherent logic of the steps/processes and should not limit the implementation process of embodiments of the present disclosure. The numbering of embodiments of the present disclosure is merely for description and does not indicate the superiority or inferiority of embodiments of the present disclosure.

The terms “include,” “comprise,” or any other variations of thereof are intended to cover non-exclusive inclusion, such that a process, method, entity, or apparatus that includes a series of elements not only includes those elements but also includes other elements not explicitly listed, or elements inherent to such a process, method, entity, or apparatus. When there are no more limitations, an element defined by the phrase “comprising a . . . ” does not exclude the existence of other identical elements in the process, method, entity, or apparatus that includes that element. In some embodiments of the present disclosure, the disclosed devices and methods can be implemented in other methods. The device embodiments described above are merely illustrative. For example, the division of units can be only a logical functional division and can have other division methods in actual implementation. For example, a plurality of units or assemblies can be combined or integrated into another system, or some features can be ignored or not executed. In addition, the coupling, direct coupling, or communication connection between the displayed or discussed components can be indirect coupling or communication connection through some interfaces, devices, or units, which can be electrical, mechanical, or in other forms.

The units described above as separate parts may or may not be physically separated. The parts shown as units may or may not be physical units and can be located in one place or distributed across a plurality of network units. The solution of embodiments of the present disclosure can be implemented by selecting some or all units of the units above as needed. In addition, the functional units of embodiments of the present disclosure can be integrated into one processing unit, the units can be each used as a unit, or two or more than two units can be integrated into one unit. The integrated unit can be implemented by hardware or by hardware plus a software unit.

Those skilled in the art can understand that all or a part of steps of the method embodiments can be implemented through the program instructing the related hardware. The above program can be stored in the computer-readable storage medium. When the program is executed, the steps of method embodiments can be executed. The above storage medium can include a mobile storage device, read-only memory (ROM), magnetic disks, optical disks, or other media that can store program codes.

Alternatively, if the integrated units of the present disclosure are implemented in the form of software functional modules and sold or used as an independent product, the integrated units can also be stored in a computer-readable storage medium. Based on this understanding, the essence or the part contributing to the related technology of the technical solutions of the present disclosure can be implemented as a software product. The computer software product can be stored in a storage medium, including several instructions used to cause the computer device (e.g., a personal computer, server, or network device) to execute some or all of the methods of embodiments of the present disclosure. The above storage medium can include a mobile storage device, ROM, magnetic disks, optical disks, and other media capable of storing program codes.

The above are only embodiments of the present disclosure. However, the scope of the present disclosure is not limited to these. Those skilled in the art can easily think of modifications or replacements in the technical scope of the present disclosure. These modifications and replacements are within the scope of the present disclosure.

What is claimed is:

1. A display method for an electronic device, the electronic device including a display screen with a variable size, comprising:
in response to detecting that a first size parameter of an expanded portion of the display screen is updated, obtaining an updated first size parameter;
based on the updated first size parameter, updating a display position of a target object displayed on the expanded portion of the display screen to obtain an updated display position; and
based on the updated display position, displaying the target object.

2. The method of claim 1, wherein in response to detecting that the first size parameter of the expanded portion of the display screen is updated, obtaining the updated first size parameter includes:
in response to any one of a power-on instruction, a lock-screen instruction, a power-off instruction, or a telescopic control instruction, detecting whether the first size parameter of the expanded portion of the display screen is updated; and
in response to detecting that the first size parameter of the expanded portion of the display screen is updated, obtaining the updated first size parameter.

3. The method of claim 1, wherein:
the updated first size parameter includes an updated expanded length of the expanded portion; and
updating the display position of the target object displayed on the expanded portion of the display screen based on the updated first size parameter includes:
based on a specific distribution ratio and the updated expanded length of the expanded portion, updating the display position of the target object in an expansion direction of the expanded portion to obtain the updated display position.

4. The method of claim 3, wherein updating the display position of the target object in the expansion direction of the expanded portion based on the specific distribution ratio and the updated expanded length of the expanded portion includes:
in response to the updated expanded length of the expanded portion being less than or
equal to a second size parameter, based on the specific distribution ratio and the updated expanded length of the expanded portion, updating the display position of the target object in the expansion direction of the expanded portion to obtain the updated display position.

5. The method of claim 3, further comprising:
in response to the updated expanded length of the expanded portion being greater than a second size parameter, based on the specific distribution ratio and an expanded length when the display screen is fully expanded, updating the display position of the target object in the expansion direction of the expanded portion to obtain the updated display position.

6. The method of claim 1, wherein updating the display position of the target object displayed on the expanded portion of the display screen based on the updated first size parameter to obtain the updated display position includes:
based on the updated first size parameter, determining a center position of the expanded portion; and
updating the display position of the target object to the center position to obtain the updated display position.

7. The method of claim 1, further comprising, before in response to detecting that the first size parameter of the expanded portion of the display screen is updated, obtaining the updated first size parameter:
in response to receiving a telescopic control instruction of the display screen, driving the display screen to expand or contract, and periodically obtaining the first size parameter.

8. The method of claim 7, wherein in response to receiving the telescopic control instruction of the display screen, driving the display screen to expand or contract, and periodically obtaining the first size parameter includes:
in response to receiving a power-on instruction, driving the display screen to expand, powering on a basic input-output system (BIOS) controller, and periodically obtaining the first size parameter;
the method further comprising, before, in response to detecting that the first size parameter of the expanded portion of the display screen is updated, obtaining the updated first size parameter:
in response to detecting that the BIOS controller is powered on, determining the display position of the target object based on the first size parameter that is most recently obtained; and
displaying the target object based on the display position of the target object.

9. The method of claim 8, wherein: in response to receiving the power-on instruction, driving the display screen to expand, powering on the BIOS controller, and periodically obtaining the first size parameter includes:
in response to receiving the power-on instruction, driving the display screen to expand, powering on the BIOS controller, and periodically obtaining the first size parameter based on a first time interval; and
in response to detecting that the first size parameter of the expanded portion of the display screen is updated, obtaining the updated first size parameter includes:
in response to detecting that the first size parameter of the expanded portion of the display screen is updated within a second time interval, obtaining the updated first size parameter;
wherein the second time interval is greater than or equal to the first time interval.

10. An electronic device comprising:
a display screen with a variable size;
one or more processors; and
one or more memories storing a computer program that, when executed by the one or more processors, causes the one or more processors to:
in response to detecting that a first size parameter of an expanded portion of the display screen is updated, obtain an updated first size parameter;
based on the updated first size parameter, update a display position of a target object displayed on the expanded portion of the display screen to obtain an updated display position; and
based on the updated display position, display the target object.

11. The device of claim 10, wherein the one or more processors are further configured to:
in response to any one of a power-on instruction, a lock-screen instruction, a power-off instruction, or a telescopic control instruction, detect whether the first size parameter of the expanded portion of the display screen is updated; and
in response to detecting that the first size parameter of the expanded portion of the display screen is updated, obtain the updated first size parameter.

12. The device of claim 10, wherein:
the updated first size parameter includes an updated expanded length of the expanded portion; and
the one or more processors are further configured to:
based on a specific distribution ratio and the updated expanded length of the expanded portion, update the display position of the target object in an expansion direction of the expanded portion to obtain the updated display position.

13. The device of claim 12, wherein the one or more processors are further configured to:
in response to the updated expanded length of the expanded portion being less than or equal to a second size parameter, based on the specific distribution ratio and the updated expanded length of the expanded portion, update the display position of the target object in the expansion direction of the expanded portion to obtain the updated display position.

14. The device of claim 12, wherein the one or more processors are further configured to:
in response to the updated expanded length of the expanded portion being greater than a second size parameter, based on the specific distribution ratio and an expanded length when the display screen is fully expanded, update the display position of the target object in the expansion direction of the expanded portion to obtain the updated display position.

15. The device of claim 10, wherein the one or more processors are further configured to:
based on the updated first size parameter, determine a center position of the expanded portion; and
update the display position of the target object to the center position to obtain the updated display position.

16. The device of claim 10, wherein the one or more processors are further configured to, before in response to detecting that the first size parameter of the expanded portion of the display screen is updated, obtaining the updated first size parameter:
in response to receiving a telescopic control instruction of the display screen, drive the display screen to expand or contract, and periodically obtaining the first size parameter.

17. The device of claim 16, wherein the one or more processors are further configured to:
in response to receiving a power-on instruction, drive the display screen to expand, powering on a basic input-output system (BIOS) controller, and periodically obtaining the first size parameter;
before in response to detecting that the first size parameter of the expanded portion of the display screen is updated, obtaining the updated first size parameter, in response to detecting that the BIOS controller is powered on, determine the display position of the target object based on the first size parameter that is most recently obtained; and
display the target object based on the display position of the target object.

18. The device of claim 17, wherein the one or more processors are further configured to:
in response to receiving the power-on instruction, drive the display screen to expand, powering on the BIOS controller, and periodically obtain the first size parameter based on a first time interval; and
in response to detecting that the first size parameter of the expanded portion of the display screen is updated within a second time interval, obtain the updated first size parameter;
wherein the second time interval is greater than or equal to the first time interval.

19. A display apparatus of an electronic device, the electronic device including a display screen with a variable size, comprising:
an acquisition module configured to in response to detecting that a first size parameter of an expanded portion of the display screen is updated, obtain an updated first size parameter;
an update module configured to based on the updated first size parameter, update a display position of the target object displayed on the expanded portion of the display screen to obtain an updated display position; and
a display module configured to based on the updated display position, display the target object.

20. The apparatus of claim 19, wherein the update module is further configured to:
in response to any one of a power-on instruction, a lock-screen instruction, a power-off instruction, or a telescopic control instruction, detect whether the first size parameter of the expanded portion of the display screen is updated; and
in response to detecting that the first size parameter of the expanded portion of the display screen is updated, obtain the updated first size parameter.
